(19) United States
(12) Patent Application Publication
(10) Pub. No.: US 2018/0043957 A1
(43) Pub. Date: Feb. 15, 2018

(54) REAR-VIEW MIRROR FOR A TWO-WHEELED VEHICLE, AND METHOD FOR THE MANUFACTURE THEREOF

(71) Applicant: motogadget GmbH, Berlin (DE)

(72) Inventor: Garrit Keller, Berlin (DE)

(73) Assignee: motogadget GmbH, Berlin (DE)

(21) Appl. No.: 15/666,211

(22) Filed: Aug. 1, 2017

(30) Foreign Application Priority Data
Aug. 15, 2016 (DE) 10 2016 115 110.6

(51) Int. Cl. B62J 29/00

(52) U.S. Cl. CPC B62J 29/00

(57) ABSTRACT

A method for manufacturing a rear-view mirror for a two-wheeled vehicle, the rear-view mirror comprising a housing and a reflective surface. In order to make the manufacture of the rear-view mirror simpler and more cost-effective, and in order to improve the mirror in terms of safety and design aspects the method including the steps of: manufacturing a blank for the housing from a metal, preferably aluminium, and forming the reflective surface as an integral component of the housing by mechanically machining at least a part of a surface of the housing, such that the reflective surface is formed in one piece with the housing. Subsequently, the reflective surface can be provided with a transparent protective layer. Furthermore, the housing can be provided with any desired external contour by mechanical machining.

### CROSS-REFERENCE TO RELATED APPLICATIONS

The present application claims priority to and all the benefits of German Patent Application No. 10 2016 115 110.6, filed on Aug. 15, 2016, which is hereby expressly incorporated herein by reference in its entirety.

### BACKGROUND OF THE INVENTION

### 1. Field of the Invention

The present invention relates to a method for manufacturing a rear-view mirror for a two-wheeled vehicle. The rear-view mirror comprises a housing and a reflective surface. The invention further relates to a rear-view mirror for a two-wheeled vehicle comprising a housing and a reflective surface, the housing being designed to be fastened to the two-wheeled vehicle by a fastening element.

### 2. Description of the Related Art

Two-wheeled vehicle mirrors of this kind are known from the prior art in various technical configurations and designs. The rear-view mirrors are fastened to the two-wheeled vehicle by a fastening element, usually in the form of a retaining arm. In this case, the mirror can be fastened to the two-wheeled vehicle at the distal end thereof, or at any other desired point on the handlebars, or even at any other desired point on the two-wheeled vehicle. A plurality of different designs are known in particular for rear-view mirrors for motorcycles. Said designs differ primarily in the differently shaped external contours of the rear-view mirror housing. The external contour of known mirrors can in particular be circular, oval, rectangular, trapezoidal, triangular or of almost any other desired shape.

The rear-view mirrors known from the prior art comprise, in addition to a mirror housing, a reflective surface that is separate from said housing and is usually in the form of a glass sheet comprising a reflective coating (mirror glass). The housing is produced from plastics material or metal. The reflective surface serves for observing a rear region behind the vehicle equipped with the mirror by the driver of the vehicle. The reflective surface must be inserted into the housing such that vibrations of the two-wheeled vehicle (on account of carriageway unevenness and/or engine vibrations) are not transferred to the reflective surface or at least do not result in damage to the mirror surface which is prone to breakage. Furthermore, the housing must comprise an edge that surrounds and encloses the mirror surface in order to protect the reflective surface and to fasten said surface to the housing.

The known rear-view mirrors are relatively complex to manufacture, since the mirror glass and the housing must be manufactured in different production facilities. Subsequently, in a first assembly step, both parts have to be assembled and the mirror glass must be fitted into the housing and fastened therein. In order to damp oscillations and vibrations, a damping material (e.g. rubber or plastics material) is usually installed between the mirror glass and the housing. Further manufacturing and assembly steps are required for this purpose.

The mirror glass used in conventional rear-view mirrors poses a significant safety risk, since people can be injured if the mirror glass breaks, for example in the event of an accident both in stationary and in moving traffic. In addition, glass splinters from broken mirror glass can jeopardise traffic safety if they are on the carriageway, since this can result in burst tyres in vehicles of other road users.

European Standard E/ECE/81 regulates the features and the manufacture of rear-view mirrors for two-wheeled vehicles that are permissible for road traffic. Other relevant standards or laws for rear-view mirrors may be in force in Europe or in other countries. According to E/ECE/81, the housing edge surrounding the mirror surface must be at least 2.5 mm wide. The reflective surface of rear-view mirrors that comply with the standards must be at least 69 cm². In the case of round rear-view mirrors, the diameter of the reflective surface must be at least 94 mm. In the case of non-round rear-view mirrors, the mirror surface must be dimensioned and designed such that a circle having a diameter of at least 78 mm can be inscribed therein. Overall, the legal requirements for conventional rear-view mirrors result in strict specifications that allow only limited freedom in the design of said mirrors. For design reasons, however, customers increasingly desire rear-view mirrors that are as small and delicate as possible. In view of this desire, the known rear-view mirrors are subject to tight restrictions.

### SUMMARY OF THE INVENTION

Proceeding from the described prior art, the object of the present invention is to resolve the goal conflict between the legal requirements for rear-view mirrors which require a specified minimum size of the reflective surface, and the desire of customers for a rear-view mirror that is as small as possible.

In order to achieve this object, the following method steps are proposed, proceeding from the method for manufacturing a rear-view mirror of the type mentioned at the outset:
manufacturing a blank for the housing from a metal, preferably aluminium, and
forming the reflective surface as an integral component of the housing by mechanically machining at least a part of a surface of the housing.

Unlike in the case of the known mirrors, in which the reflective surface is formed by a separate piece of mirror glass that is inserted into the mirror housing, in the present invention the reflective surface is an integral component of the housing. The mechanically machined surface of the housing or the machined part of the surface has a reflection factor that corresponds to or is even better than that of conventional mirror glass. The reflection factor (also referred to as the reflecting power, reflectivity or reflectance), ρ, is the ratio of the reflected intensity to the incident intensity of the light.

The rear-view mirror according to the invention is advantageous in that it can be manufactured in a particularly simple, time-saving and cost-effective manner. In particular, there is no need for a separate tool shop for the special mirror glass used for two-wheeled vehicles, and it is not necessary to manufacture and assemble the mirror glass separately. The entire rear-view mirror can be manufactured in a cost-effective and flexible manner on a single workstation, in particular in a single CNC machine. In particular, a convex curvature of the mirror surface can be produced in a flexible manner, with the result that different fields of vision of the mirror can be achieved easily. Moreover, the rear-view mirror is also significantly better in terms of safety aspects than the rear-view mirrors for two-wheeled vehicles known up to now, since said mirror is unbreakable. Finally, the rear-view mirror also makes a particularly appealing design possible, since it does not require an edge surrounding the reflective surface on the outside, and therefore at least 2.5 mm of edge can be saved all around and said mirror can thus have a diameter that is at least 5 mm smaller, in plan view, than that of the conventional rear-view mirrors comprising separate mirror glass. In the case of round rear-view mirrors having a reflective surface diameter of 94 mm (overall diameter of the conventional mirror thus 99 mm), this still corresponds to a diameter that is reduced by at least 5%. In the case of non-round mirrors having an inscribed circle that has a diameter of 78 mm (minimum height or width of the conventional mirror thus 83 mm), this still corresponds to a reduction of at least 6% in the overall surface area of the mirror. Moreover, the mirror can also be formed so as to be particularly thin and compact overall. Said mirror has only a low weight, in particular when correspondingly light-weight materials are used for the housing. Rapid and flexible individualisation can be achieved using different covers that can be fastened to the housing. Finally, semiconductor light sources (LEDs) or other electrical or electronic components, for example a camera, can also be easily mounted on the mirror housing using the covers.

In order to manufacture the rear-view mirror, first of all a blank is manufactured for the housing. Said blank can be worked out of a single block of material, for example a metal, in particular aluminium, for example by mechanical machining using a suitable cutting tool. A milling tool, for example, can be used as the cutting tool. This processing step can be carried out in a CNC machine. The blank is preferably produced so as to be rotationally symmetrical, irrespective of the desired external contour of the finished rear-view mirror. The blank is preferably already provided with all the required fastening elements and other details (e.g. three-dimensional design elements, wind deflectors or wind-guiding elements, recesses and grooves or holes for light sources and the electrical supply thereof, etc.). In order to prevent corrosion of the rear-view mirror and in order to achieve a desired aesthetic impression of the finished mirror, the finished housing blank is preferably anodised or coated in another manner.

In order to produce the reflective surface, at least a part of a surface of the housing blank, which surface is intended to form the reflective surface, is in turn mechanically machined. This can be carried out in the same machine as the manufacture of the housing blank. The mechanical machining for manufacturing the mirror surface is preferably carried out using a monocrystalline diamond cutting tool. Said tool can remove very thin layers of the material of the blank, of in the region of a few tenths of a millimetre. A reflective surface is thus produced that without difficulty meets the requirements for a rear-view mirror reflective surface that is distortion-free and has the desired reflective efficiency. Optionally, the reflective surface can subsequently also be polished or mechanically machined in another manner using another tool in order to improve the mirror effect.

Following the mechanical machining of the part of the housing that forms the mirror surface, advantageously at least the part of the housing that forms the reflective surface is coated with a protective layer that is transparent after curing or baking. Of course, the entire blank can also be provided with the reflective surface comprising the protective layer. The protective layer can be a curable liquid varnish or a baked powder coating. The protective layer can, however, also be a SiOx layer deposited in a plasma. The protective layer is preferably designed to protect the reflective surface at least from chemical or mechanical stress. Chemical stress can lead to discolouration or fatigue of the mirror surface and may result, for example, from solar radiation, in particular from UV rays, or from corrosion on account of weather influences, in particular humidity. Mechanical stress may result, for example, from sand or dust particles in conjunction with a wiping motion over the mirror surface, or from pointed or sharp objects, and can lead to scratches.

When coating the part of the housing that forms the mirror surface, a curable varnish can be applied in one or more layers until the desired layer thickness has been built up. Those resins based on cross-linkable acrylate, polyester or polysiloxane are used as a resin for varnishes. Systems are known in which the pre-polymerised cross-linkable plastics material is dissolved in organic solvents. Furthermore, acrylate-based aqueous systems are known. Moreover, solvent-free systems are known, in which a prepolymer is dissolved in liquid monomers. The monomers used as the solvent are then absorbed into the varnish layer when cured.

When coating the part of the housing that forms the mirror surface, a powder coating can be baked on. The powder coating is preferably highly reactive, and melts at relatively low temperatures. Coating powders of this kind melt, when gently warmed, to form a non-porous film having a smooth surface and, after curing, provide the mirror surface with the desired properties. The stone-chip resistance is, for example, within the specifications according to TRANS/SCI/WP.29/GRE (sandblasting testing). Excellent adhesion of the powder coating to the surface of the housing to be coated is achieved. This can be seen from the cross-cut value, which complies with DIN 53151 Gt0 (DIN EN ISO 2409). The reflection factor of the machined surface of the housing that forms the mirror surface is not, or not noticeably, impaired by the coating.

The coating consists, for example, of a cross-linked synthetic resin, in particular a polyacrylate. Other powder coating systems can also be used, however, such as those based on polyester or polyurethane. The layer thickness of the coating in the optical region of the mirror surface is generally between 30 and 200 μm, preferably between 60 and 150 μm, more particularly preferably between 80 and 120 μm. Large layer thicknesses provide good protection for the mirror surface, whereas smaller layer thicknesses may be preferred for reasons of cost or may be used where there is less stress on the mirror surface. The layer thickness is generally greater than 40 μm.

Forming the coating both as a cured liquid varnish and as a baked powder coating makes it possible to achieve very uniform layer thicknesses. Thus, variations in the layer thickness of less than ±10%, in particular less than ±5%, can be maintained in the centre of the mirror surface. Variations are less critical in the edge region. There, the layer thickness of the coating is in any case preferably smaller, in particular in the range of between 40 and 60 μm.

Preferably, a low-melting powder coating material is used, which material has a low viscosity and is highly reactive when melted. The low viscosity after being melted on provides a rapid and clean flow of the protective layer. The high reactivity of the powder material results in rapid curing, and therefore the heating time can be limited, which has a positive effect both for the energy requirement and for the dimensional stability of the housing. Preferably, a powder coating material is used that, when melted, initially has a melting viscosity of from 300 to 6000 mPa·s, in particular 1000 to 3000 mPa·s, the viscosity rapidly increasing as the cross-linking progresses. Furthermore, a coating powder is advantageously used that sinters at temperatures of between 50 and 90° C. and melts at temperatures in the range of from 70 to 130° C., in particular 80 to 120° C. The particle size of the powder material is preferably smaller than the desired layer thickness of the layer to be formed. The average particle size of the powder material is advantageously in the range of from 15 to 55 μm, in particular 15 to 25 μm.

Coating powders that are suitable for forming a transparent, colourless coat are known per se. Highly reactive acrylic resins that contain epoxy groups are preferred. Acrylates of this kind can be excellently cross-linked using organic polyanhydrides or polyacids as cross-linking agents. Systems based on polyesters containing carboxy groups, which polyesters can be cross-linked using triglycidyl isocyanurate for example, are also suitable. In addition, polyurethane-based systems are suitable.

In order to capture and to melt on the coating powder, in each case the surface to be coated of the housings is heated to temperatures in the range of from 80 to 170° C., in particular 100 to 140° C. In the process, the temperature of the surface can be measured using pyrometers (radiation thermometers). Heating to reach the melting temperature can be carried out using hot air and/or exposure to IR radiation. Hot air alone or a combination of exposure to IR radiation and hot air is preferred in this case. It is generally advantageous to heat the surface of the housing to at least 20° C. above the upper temperature of the melting range of the powder coating material. Such preheating of the housing can be carried out over a period of from 5 to 60 minutes, in particular 10 to 15 μminutes.

The coating powder is preferably applied to the surface of the housing to be coated in a manner known per se, in an air stream. Conventional electrostatic guns can be used, although in general no current is applied. The operation can be carried out under the following conditions, for example: conveying air 1.7 bar; metering air 5.5 m³/h; additional air 0.3 m³/h. As already described above, the amount of heat required during coating in order for the powder coating to be melted on and to flow is preferably delivered exclusively from the preheated mirror housing. In this case, the heating can even be limited to the surface of the housing to be coated, with the result that there is no through-heating whatsoever of the housing. Preferably, only the surface of the housing that acts as the reflective surface when in use (oriented counter to the direction of travel) is coated, and therefore also only this surface needs to be heated.

After the coated housing has been cooled, the rear-view mirrors are ready to use without further treatment. The baked powder coatings have an excellent optical quality and a flawless surface. Tests have shown that the requirements placed on rear-view mirrors for two-wheeled vehicles with regard to optical quality, mechanical stress and resistance to chemicals and solvents are met in an excellent manner.

According to an advantageous development of the invention, it is proposed for the housing to be shaped into the desired external contour thereof by mechanical machining after the part of the housing that forms the reflective surface has been coated with the protective layer. Rear-view mirrors having a round external shape can be produced directly from rotationally symmetrical, anodised metal blanks. Rear-view mirrors having a non-round external shape are also produced from rotationally symmetrical blanks. In the case of these mirrors, however, the desired external contour is manufactured after coating the reflective surface. Said contour can be produced for example by mechanical machining, in particular using a milling tool. In this case, the same CNC machine can be used as for the preceding machining steps. As a result, the rear-view mirror or the housing thereof and the reflective surface can be made into almost any desired shape.

According to a preferred embodiment of the invention, the housing comprises a fastening portion, outside the part of the housing that forms the reflective surface, for fastening a proximal portion of the fastening element. In particular, when the rear-view mirror is fastened to the two-wheeled vehicle, the fastening portion is formed on a rear side of the housing oriented in the direction of travel of the two-wheeled vehicle or on a lower edge of the housing. Advantageously, the fastening portion and the proximal portion of the fastening element are operatively interconnected such that it is possible to adjust the rear-view mirror relative to the fastening element and transversely to a main plane of extension of the reflective surface. The orientation of the rear-view mirror or of the reflective surface can thus be adjusted. This can be achieved, for example, by a ball head that is formed on the proximal portion of the fastening element. The ball head is adjustably mounted in a corresponding receptacle on the mirror housing. In this case, the fastening portion is therefore designed as a receptacle for a ball head. The fastening element is formed for example as a retaining arm, the distal end of which is preferably also adjustably fastened to the handlebars or to any other desired point on the two-wheeled vehicle.

According to a further embodiment of the invention, it is proposed for the rear-view mirror to comprise a cover, preferably made of plastics material, that is fastened to the housing and is outside the part of the housing that forms the reflective surface. Particularly preferably, the cover extends at least over part of a surface on the rear side of the housing that is opposite the reflective surface (and is oriented in the direction of travel when the rear-view mirror is mounted). This cover makes it possible to vary the design of the rear-view mirror in a simple manner, in that the cover has a specific shape and a specific appearance (colour, pattern, etc.). It is furthermore conceivable for the cover to provide a particularly streamlined shape for the rear-view mirror. Moreover, the cover can comprise air-guiding elements and spoilers in order to reduce the flow noise.

According to another advantageous development of the invention, it is proposed for the rear-view mirror to comprise at least one light source, preferably a semiconductor light source, outside the part of the housing that forms the reflective surface. The light source can be supplied with electricity and controlled via lines that extend inside the fastening element and in corresponding channels or holes in the housing and lead from the two-wheeled vehicle to the light source. The light source can implement any desired illumination functions, for example indicator lights, daytime running lights, navigation lights or tail lights. A plurality of light sources may also be provided, which produce a single or different illumination functions. The light sources can emit light of the same or of different colours. A semiconductor light source is particularly compact and is highly efficient.

Finally, it is proposed for the rear-view mirror to comprise a plastics material cover that is fastened to the housing and is outside the part of the housing that forms the reflective surface, which cover comprises transparent portions at least in part and is positioned relative to the at least one light source such that light emitted by the at least one light source passes through the transparent portions of the cover. The transparent portions of the cover thus simultaneously function as a cover disc or diffusing panel for the light sources arranged in or on the housing.

### BRIEF DESCRIPTION OF THE DRAWINGS

Further features and advantages of the present invention will be explained in greater detail in the following, on the basis of the figures which illustrate preferred embodiments of the invention and in which, in detail:

FIG. 1 is an exploded view of a preferred embodiment of a rear-view mirror according to the invention for a two-wheeled vehicle;

FIG. 2 is a cross-section of the rear-view mirror according to the invention according to FIG. 1;

FIG. 3 is a perspective view of the rear-view mirror according to the invention from FIGS. 1 and 2 when mounted on handlebars of the two-wheeled vehicle;

FIG. 4 shows a method step within the context of manufacturing the rear-view mirror according to the invention;

FIG. 5 shows another method step within the context of manufacturing the rear-view mirror according to the invention;

FIG. 6 shows yet another method step within the context of manufacturing the rear-view mirror according to the invention;

FIG. 7 shows a further method step within the context of manufacturing the rear-view mirror according to the invention;

FIG. 8 shows the method step from FIG. 7 in a plan view of the rear-view mirror; and

FIG. 9 is a perspective view of another preferred embodiment of a rear-view mirror according to the invention for a two-wheeled vehicle when mounted on handlebars of the two-wheeled vehicle.

### DETAILED DESCRIPTION OF THE INVENTION

The present invention relates to a rear-view mirror for a two-wheeled vehicle, and to a method for the manufacture thereof. Conventional rear-view mirrors known from the prior art generally have a housing made of metal or plastics material, and separate mirror glass that forms the reflective surface of the rear-view mirror and is fastened in the mirror housing. Suitable rubber or plastics damping elements are usually arranged between the mirror housing and the mirror glass in order to keep vibrations caused by an engine of the two-wheeled vehicle or by carriageway unevenness away from the mirror glass or to transfer said vibrations to said mirror glass only in a damped manner, such that damage to, in particular breakage of, the mirror glass is prevented. Manufacturing a rear-view mirror of this kind requires relatively significant outlay in terms of material and time requirements. Different machines are required for manufacturing the housing, the mirror glass and the damping elements, and the individual parts have to be assembled to form the rear-view mirror in an additional assembly step. The known rear-view mirror is also problematic in terms of safety aspects since, if the mirror glass breaks, glass splinters could cause injury to the driver of the two-wheeled vehicle or to other people, and could endanger traffic due to burst tyres. Moreover, the conventional rear-view mirrors of the type mentioned comprise a peripheral edge in order to be able to better retain the mirror glass and to protect the entire periphery of said glass from damage. As a result, the conventional rear-view mirrors are unnecessarily large when seen in a plan view of the mirror surface. This may be undesirable for reasons of design and style.

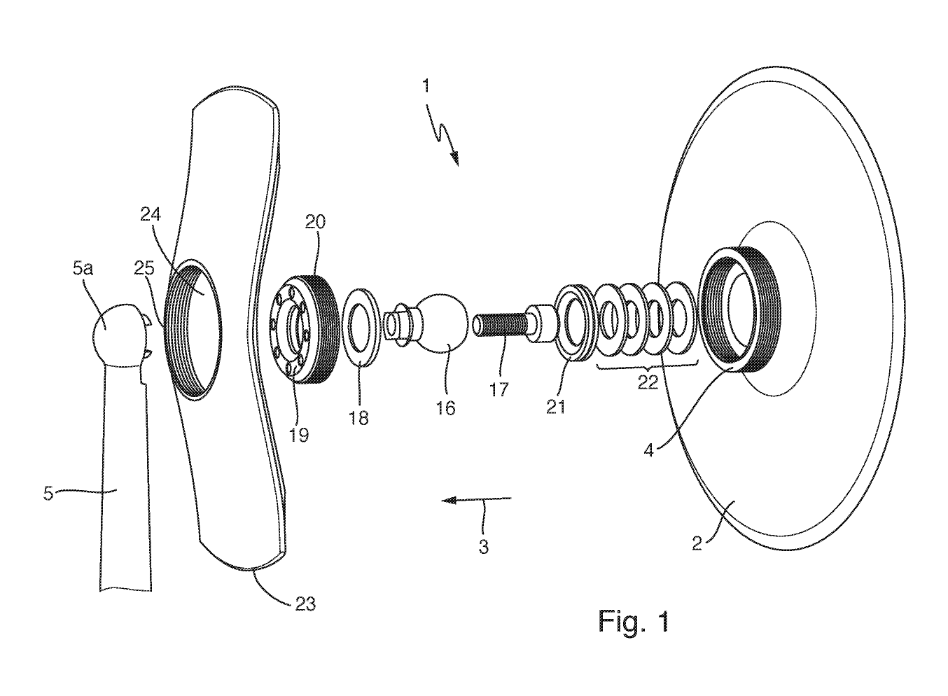

The rear-view mirror according to the invention can remedy this. FIG. 1 is an exploded view of a first embodiment of a rear-view mirror according to the invention, denoted in its entirety by reference sign 1. The rear-view mirror 1 comprises a housing 2 that has a fastening portion 4 on the rear side thereof oriented in the direction of travel 3 when the rear-view mirror 1 is mounted, which fastening portion is intended for fastening the housing 2 to the two-wheeled vehicle, preferably to handlebars of the two-wheeled vehicle, by a fastening element 5. The fastening element 5 is preferably formed as a retaining arm, the proximal portion 5a of which is indirectly and adjustably fastened to the fastening portion 4 of the mirror housing 2 such that it is possible to adjust the orientation of the rear-view mirror 1 relative to the fastening element 5. In this case, the adjustability of the rear-view mirror 1 is preferably sufficiently tight that airflow and slight mechanical impacts on the mirror 1 cannot cause displacement of the rear-view mirror 1. A reflective surface is formed on the front side of the mirror 1 opposite the rear side.

The mirror housing 2 is a substantial component of the rear-view mirror 1 according to the invention. Said housing is preferably produced from a single piece. It is proposed in particular for the housing 2 to be produced from a metal, particularly preferably aluminium. In a first method step for manufacturing the rear-view mirror 1 according to the invention, it is proposed that a rotationally symmetrical blank be produced from a single piece of metal, which blank then ultimately forms the housing 2. The blank comprises all the necessary threads and details, such as the fastening portion 4. The finished blank is therefore already substantially in the shape of the housing 2 of the finished rear-view mirror 1. The metal blank is produced in large numbers as a mass product, preferably in a particularly cost-effective manner using CNC machines that are readily available commercially. Of course, it is also conceivable for the housing 2 to consist of a plurality of parts or to comprise a plurality of parts that are produced individually and then fastened together in order to form the housing 2. In addition to the metal part, the housing 2 can comprise any number of further parts that are also made of metal or of other materials, for example plastics materials, and are fastened to the metal part. After the blank has been produced it can be provided with any desired coating. It is intended in particular for the blank to be anodised.

Subsequently, the mirror surface is formed on a part of the housing 2 as an integral component of the housing 2. The mirror surface is preferably formed on the rear side of the housing 2 that is oriented counter to the direction of travel 3 of the two-wheeled vehicle. This will be explained in detail in the following.

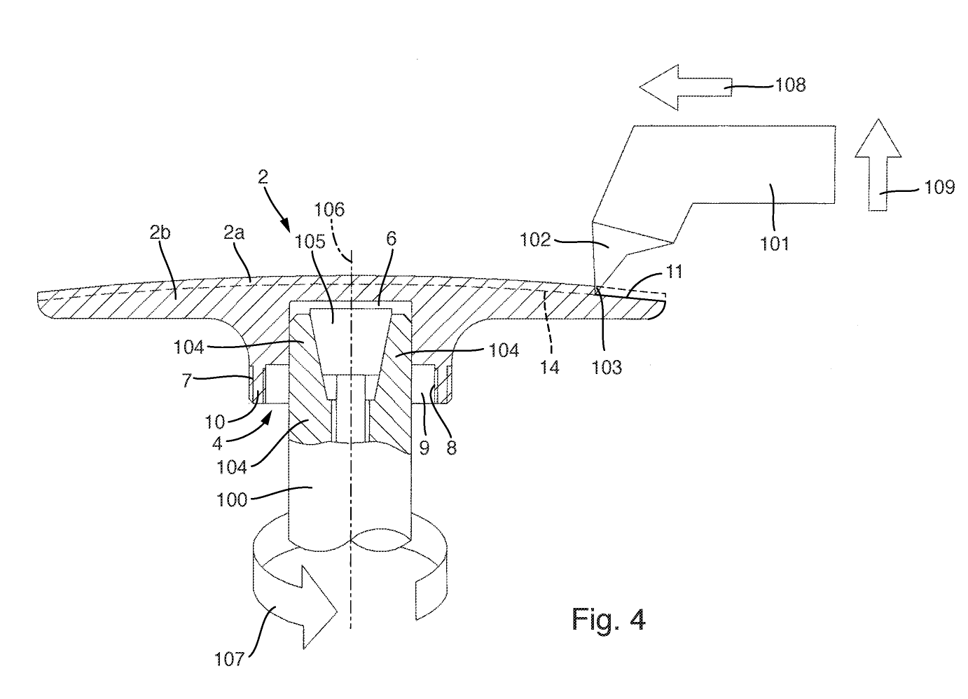

FIG. 4 is a sectional view of the blank that ultimately forms the housing 2. Only the part of the blank that is intended to form the reflective surface 11 of the rear-view mirror 1 requires further machining. A blind hole 6 is formed on the rear side of the housing 2 as part of the fastening portion 4, into which hole a retaining element 100 having retaining jaws 104 that are movable in the radial direction is inserted. In addition to the blind hole 6, the fastening portion 4 further comprises a recess 9, the diameter of which is greater than the diameter of the blind hole 6. The recess 9 is delimited in the radial direction by a collar-like element 10. An external thread 7 of the fastening portion 4 is formed on an outer peripheral edge of the collar-like element 10, and an internal thread 8 of the fastening portion 4 is formed on the inner peripheral edge of the element 10.

The retaining element 100 can be a component of the same CNC machine that has already been used for the preceding method step, or of another CNC machine. The retaining element 100 preferably comprises three retaining jaws 104, on the radially inwardly oriented inner faces of which oblique sliding surfaces are formed, which surfaces define an inner chamber having a diameter that decreases in a direction oriented away from the housing 2 (from top to bottom in FIG. 4). A conical clamping element 105 is arranged in the inner chamber defined by the retaining jaws 104, which clamping element is movable along a longitudinal or rotational axis 106 of the retaining element 100. The retaining or clamping jaws 104 are pressed radially outwards by the clamping element 105 being moved into the inside of the retaining element 100 (downwards in FIG. 4). The housing 2 is thus firmly held on the retaining element 100. In order to further machine the housing 2, in particular in order to form the reflective surface 11 on the front side of the housing 2, the retaining element 100, together with the housing 2 that is fastened thereto, is rotated about the longitudinal axis 106 in the direction 107.

The part of the housing 2 that is intended to form the reflective surface 11 in the finished rear-view mirror 1 requires further machining. In the example shown here, the reflective surface 11 is formed on the entire front side of the housing 2 that is substantially oriented counter to the direction of travel 3. For this purpose, the entire front side of the housing 2 is mechanically machined by a milling or cutting tool 101 in order to remove a thin layer 2a of the material of the housing 2 such that the material 2b of the housing 2 remains. The tool 101 can comprise a monocrystalline diamond cutting tool 120 for example, so that the reflective surface 11 resulting after the material 2a has been removed is of particularly high optical quality. Using a monocrystalline diamond cutting tool 101, 102, it is possible in particular to produce a reflective surface 11 of which the quality corresponds to the optical properties of conventional mirror glass without further mechanical machining of the mirror surface 11, for example by polishing, being required. Of course, it is also possible, however, for the reflective surface 11 to undergo secondary machining, for example by polishing, after the material 2a has been removed, in order to improve the quality. Manufacturing the reflective surface 11 from the blank can also be carried out in a conventional CNC machine. Preferably, the same machine is used for this purpose as that in which the blank was previously manufactured. It is thus possible, in the same CNC machine, to first produce the blank for the housing 2 and to subsequently form the reflective surface 11 on the front side of the blank. The cutting tool 101 can be moved relative to the blank in directions 108, 109 such that a tip 103 of the cutting tool 101 is moved along a cutting edge 14. The mirror surface 11 is produced by interaction of the rotary movement 107 of the housing 2 about the rotational axis 106 with the movement of the cutting tool 101 in the directions 108, 109. The thickness of the material 2a to be removed from the front side of the blank is just a few tenths of a millimetre. After the material 2a of the blank has been removed, the reflective surface 11 is formed by the bare metal material of the blank.

In one embodiment, the reflective surface 11 has a convex curvature. In particular, the curvature can be rotationally symmetrical about the axis 106. It should be noted that the reflective surface 11 extends on the front side of the housing 2 as far as the outer edge of the housing 2, with the result that the entire front side of the housing 2 forms the reflective surface 11. Therefore, no outer edge portion of the housing 2 remains that peripherally surrounds the reflective surface 11. The rear-view mirror 1 according to the invention can therefore be particularly small and delicate, while still complying with all the legal requirements for the minimum size of the reflective surface 11.

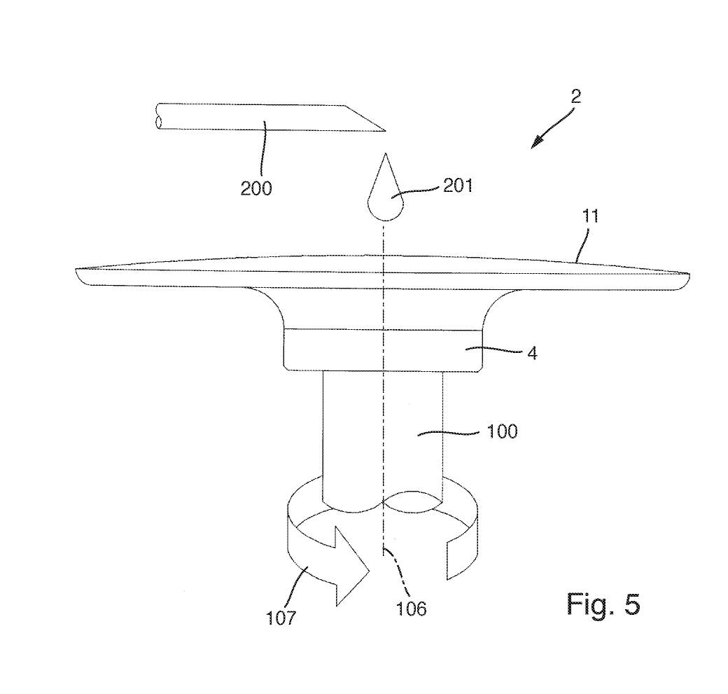

In order to maintain the resistive properties of the reflective surface 11 for a long period of time despite chemical, mechanical and weather-related influences, a protective layer is applied to the reflective surface 11. A first example of how this method step can be implemented is shown in FIG. 5. In this case, the housing 2, together with the bare reflective surface 11 produced previously, is still held, in the manner described above, on the retaining element 100 and is rotated about the longitudinal or rotational axis 106 in direction 107. The retaining element 100 can be a component of the same CNC machine that has already been used for the preceding method step, or of another CNC machine.

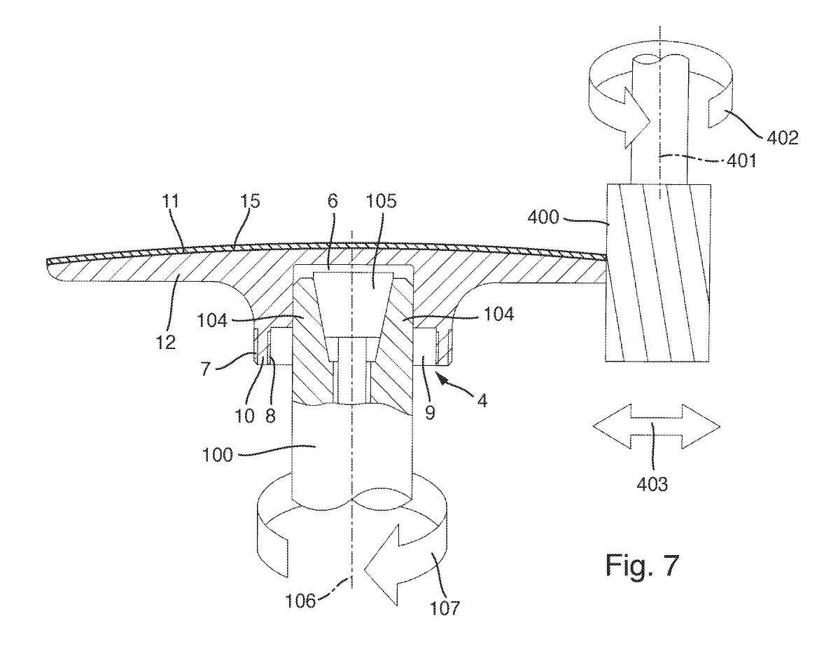

An outlet opening of a nozzle 200 is directed towards the front side of the housing 2 and/or towards the mirror surface 11. A liquid varnish 201 is applied by the nozzle 200 approximately to the centre of the reflective surface 11, on the front side of the housing 2. On account of the rotation of the housing 2 about the axis 106 and the effect of the centrifugal forces, the liquid varnish 201 applied flows from the centre of the mirror surface 11 to the outer edge. In this way, the entire mirror surface 11 can be uniformly covered with liquid varnish. The layer thickness of the liquid varnish, and thus the resulting protective layer 15 (cf. FIG. 7), can be influenced by the viscosity of the liquid varnish 201 and by the speed of rotation of the housing 2 about the rotational axis 106. The layer thickness does not need to be constant over the entire mirror surface 11. It is conceivable, for example, for the protective layer 15 to have a greater layer thickness in the centre of the mirror surface 11, approximately in the region of the axis 106, than on the outer edge of the mirror surface 11.

The liquid varnish applied to the entire mirror surface 11 cures and thus forms the protective layer 15. The liquid varnish can cure at room temperature, or not until heated. It is likewise conceivable for the liquid varnish to cure only by exposure to electromagnetic radiation, for example in the UV wavelength range. The cured liquid varnish forms a transparent protective layer 15 that withstands chemical and weather-related influences. In particular, the protective layer 15 does not discolour on account of solar radiation and is resistant to conventional cleaning agents and other liquids, such as oil or petrol. Furthermore, the protective layer 15 is very hard and therefore is not easily scratched.

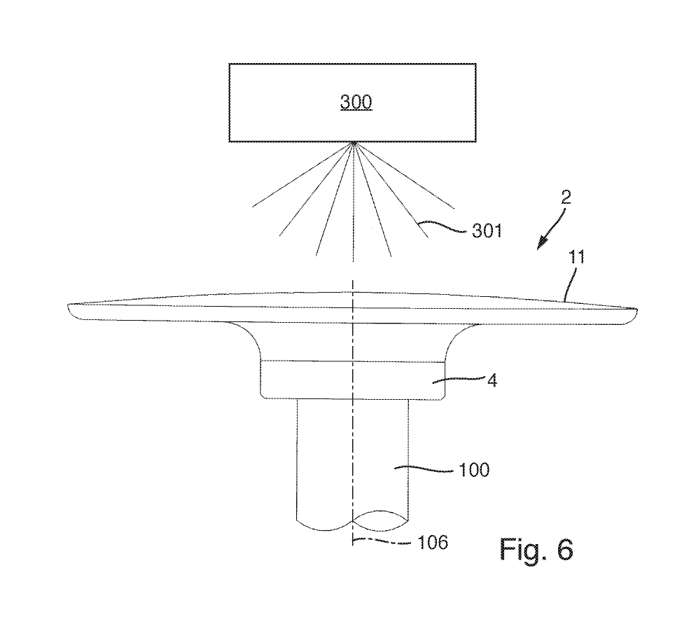

An alternative method for applying the protective layer to the reflective surface 11 is shown in FIG. 6. In this case, the housing 2 can, as before, be held in the retaining element 100, rotation of the housing 2 about the axis 106 not being required. It is still possible, however, for the housing 2 to rotate about the longitudinal or rotational axis 106, for example at a lower speed of rotation than in the embodiment in FIG. 5. A spraying unit 300 is arranged on the front side of the housing 2, which unit pulverises a material 301 that forms the subsequent protective layer 15 and applies said material to the entire mirror surface 11. In a similar manner to that in the embodiment in FIG. 5, the material 301 can be a liquid varnish that is sprayed over the entire surface 11 as a fine mist having small liquid droplets. In this case, the liquid varnish cures in the manner already described above for FIG. 5. It would also be conceivable, however, for the material 301 to be a powder coating that is applied to the mirror surface 11 as a dust mist having small powder particles. The powder particles of the powder coating can, for example, melt by being heated and subsequently cure, and thus form the optically transparent protective layer 15. Detailed explanations regarding the powder coating that forms the protective layer 15 can be found in the introductory part of the description of the present patent application, and will not be repeated here.

The housing 2 of the rear-view mirror 1 according to the invention is thus formed having the reflective surface 11 on the front side thereof, and said surface is provided with a protective layer 15 (cf. FIG. 7). The housing 2 and the reflective surface 11 of the rear-view mirror 1 according to the invention can be manufactured quickly and cost-effectively in a single CNC machine. Even coating of the mirror surface 11 with a liquid varnish or powder coating for manufacturing the protective layer 15 can be carried out in the same CNC machine. Laborious assembly of different individual parts of the rear-view mirror 1, as is required in the prior art for example, in which the housing and the mirror glass must be assembled, is likewise omitted in the present invention. In addition, the rear-view mirror 1 according to the invention is substantially safer than conventional rear-view mirrors, since the use of fragile mirror glass can be omitted. Finally, the rear-view mirror 1 according to the invention allows an entirely new design emphasis, since the edge of the housing 2 that surrounds the mirror surface 11 on the outside can be omitted and the rear-view mirror 1 can be designed so as to be substantially smaller, in plan view, than conventional rear-view mirrors.

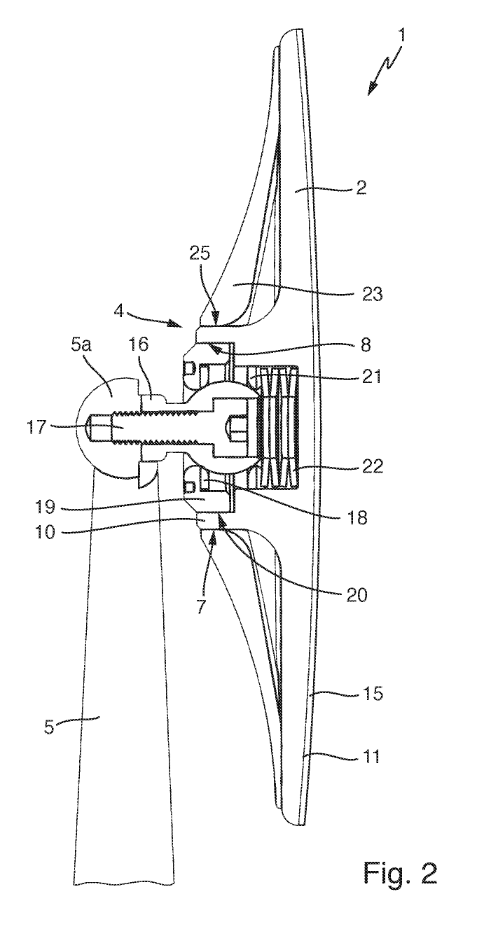

The finished rear-view mirror 1 now only needs to be fastened to the fastening element 5. For this purpose, a ball head 16 is firmly screwed to the proximal portion 5a of the fastening element 5 by a screw 17. A washer 18 and a ring nut 19 comprising an external thread 20 are also arranged between the ball head 16 and the proximal portion 5a. The external thread 20 of the ring nut 19 is dimensioned such that it can be screwed into the internal thread 8 of the fastening portion 4 of the housing 2. The fastening portion 4 of the housing 2 is then placed on the ball head 16, a sliding bearing 21, which slides on the outer surface of the ball head 16 when the housing 2 is mounted, and a plurality of curved washers 22 (known as split lock washers or spring washers), being arranged between the fastening portion 4 and the ball head 16. The washers 22 form a spring element, as can be seen in FIG. 2, in order to achieve the necessary rigidity of the adjustment of the rear-view mirror 1 relative to the fastening element 5.

In order to mount the rear-view mirror 1 on the proximal end 5a of the fastening element 5, the housing 2 is screwed, by the internal thread 8 of the fastening portion 4, onto the external thread 20 of the ring nut 19 which, as mentioned, is fastened by the screw 17 and the ball head 16 to the proximal end 5a of the fastening element 5. The spring element 22 is now arranged in the blind hole 6 of the fastening portion 4 (cf. FIG. 2). The more firmly the housing 2 is screwed to the ring nut 19, the greater the spring force exerted by the washers 22 and the more difficult it is to adjust the rear-view mirror 1 relative to the fastening element 5.

Finally, a cover element 23 can be screwed onto the external thread 7 of the fastening portion 4 of the housing 2. The cover element 23 can consist of any desired material, for example plastics material or metal. In addition, said element may be of any desired shape and colour. In the embodiment shown, the cover element 23 is arched and consists of metal. Said element comprises an opening 24 having an internal thread 25 that corresponds to the external thread 7 of the fastening portion 4. The cover element 23 can have the function of guiding the airflow and/or reducing noise caused by the airflow. Moreover, the cover element 23 could have the function of stabilising the housing 2. Finally, it would also be conceivable for the cover element 23 to be used additionally or purely for design aspects. The fact that different cover elements 23 can be fastened to the same housing 2 of a rear-view mirror 1 makes it possible to achieve very different designs of the rear-view mirror 1. The cover element 23 can thus fulfil various purposes:

specific shape for low drag and/or low wind noise of the mirror 1,

specific shape and surface finish (pattern, colour, etc.) for a specific design, and

receiving electrical components of the two-wheeled vehicle, including LEDs for implementing an illumination function, or a camera for implementing a lane departure warning system or a collision prevention system for the two-wheeled vehicle.

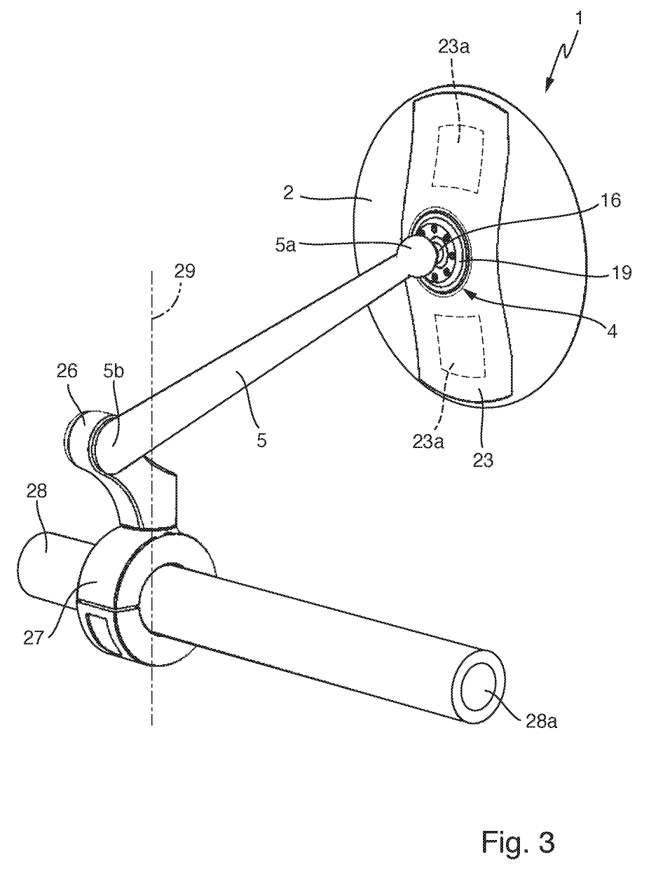

The rear-view mirror 1 together with the fastening element 5 that is movably fastened thereto can be fastened to any desired point on a two-wheeled vehicle by the distal end 5b of the fastening element 5. FIG. 3 shows an embodiment in which the distal end 5b of the fastening element 5 is fastened to handlebars 28 of a two-wheeled vehicle by a corresponding adapter element 26 and a retaining ring 27 that is fastened thereto so as to be rotatable about a rotational axis 29. Of course, the rear-view mirror 1 can also be fastened to the two-wheeled vehicle in any other desired manner than that shown here. It is likewise conceivable for the rear-view mirror 1 to be fastened to a different point of the two-wheeled vehicle from that shown here, for example to the distal end 28a of the handlebars 28.

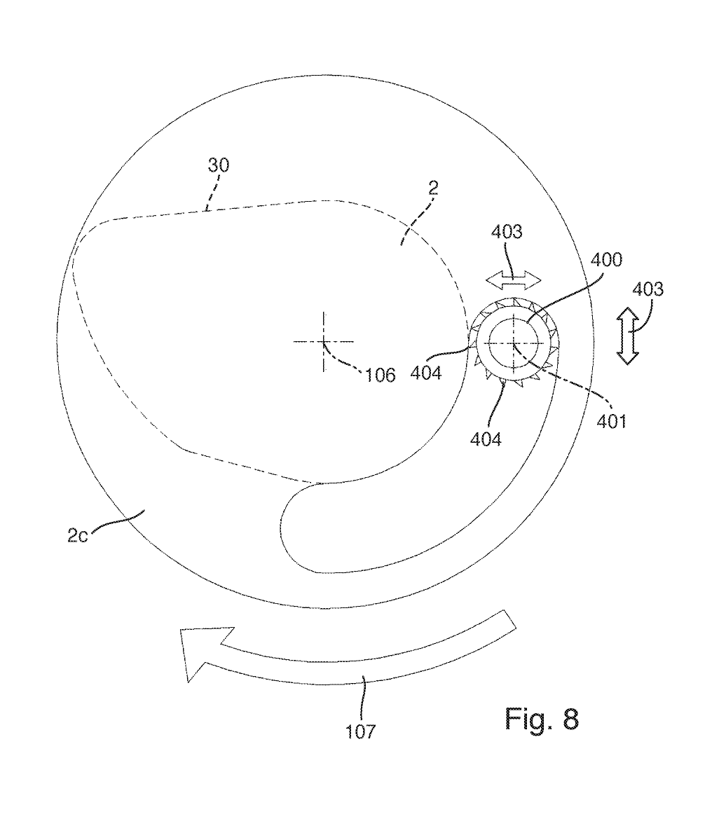

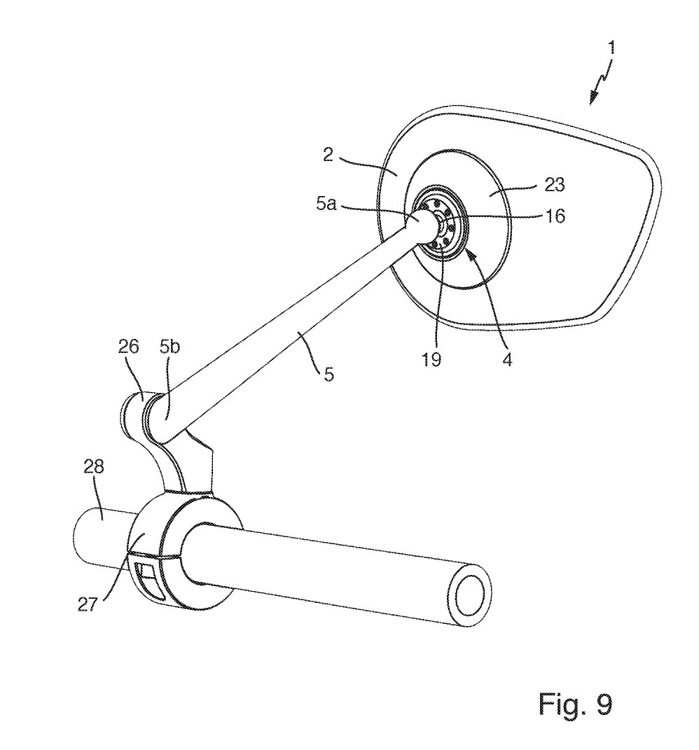

The embodiment described thus far of a rear-view mirror 1 according to the invention relates to a rear-view mirror 1 having a circular, rotationally symmetrical external contour. The present invention, however, also relates to rear-view mirrors 1 that have any desired external contour that is not circular. Non-circular rear-view mirrors 1 of this kind can in particular have an oval, trapezoidal, rectangular, triangular or any other desired external contour. A rear-view mirror of this kind is shown in FIG. 9 for example. The way in which the non-rotationally symmetrical rear-view mirror 1 of FIG. 9, or any other desired non-rotationally symmetrical rear-view mirror 1, can be manufactured, in a subsequent further method step, from the rotationally symmetrical circular rear-view mirror 1 manufactured according to the method steps of FIG. 4 to 6, will be explained in the following with reference to FIGS. 7 and 8.

For this purpose, the housing 2 having the reflective surface 11 formed on the front side and the protective layer 15 applied thereto is again fastened in the retaining element 100 of the CNC machine used for the preceding method steps. The method step described below can thus also be carried out in the CNC machine in which the preceding method steps according to FIG. 4 to 6 were already carried out. Of course, the retaining element 100 can also be a component of a different CNC machine.

A further material-removing tool 400 is now used that is designed, for example, as a milling tool and that rotates about its longitudinal or rotational axis 401. The rotational movement is shown by way of example in FIG. 7 by the arrow 402. The milling tool 400 can be moved in the main plane of extension of the reflective surface 11, such that material can be removed from the periphery of the rotationally symmetrical housing 2. The movement of the milling tool 400 is indicated by a double-headed arrow 403. In particular, the milling tool 400 is moved relative to the rotationally symmetrical housing 2 in the directions 403 such that a cutting edge 404 of the tool 400 (cf. FIG. 8) moves along a desired external contour 30 of the non-rotationally symmetrical rear-view mirror 1. In this way, material 2c can be removed from the rotationally symmetrical housing 2 along the external contour 30. In addition to the movement of the milling cutter 400 in the directions 403, the housing 2 can be rotated about the rotational or longitudinal axis 106 in direction 107. The rotation 107 of the housing 2 interacts with the movement of the milling tool 400 such that the cutting edges 404 are moved along the desired external contour 30.

Following this machining step, a non-rotationally symmetrical rear-view mirror 1 is obtained that has any desired external contour 30 that is not a circle. Likewise, external material 2c can be removed from the circular housing 2 in the manner described, in order to obtain a rear-view mirror 1 that is again circular but that has a smaller diameter than the original circular rear-view mirror. In this case, the external contour 30 would therefore be a circle having a smaller diameter than the original rotationally symmetrical mirror 1. If desired, the cutting edge along the external contour 30 can be deburred or rounded off in a further processing step that can also be carried out in the CNC machine. In the embodiment in FIG. 9 the cutting edge along the external contour 30 is rounded off towards the rear side of the housing 2 (in the direction of travel) for example. Since the coating applied to the blank, for example the anodised layer, has now been removed, at least in part, along the external contour 30 together with the material 2c, the metal, which is now again bare, can again be provided with a coating, in particular be anodised.

In contrast to the embodiment in FIG. 1 to 6, in the embodiment described now of a rear-view mirror 1 according to the invention, the cover element 23 is designed in a different manner. In particular, the cover element 23 of the rear-view mirror in FIG. 9 is domed and surrounds the entire periphery of the collar-like element 10 and/or of the fastening portion 4 of the housing 2.

It is further conceivable for the cover element 23 to consist at least in portions, or possibly even completely, of a transparent material. It is thus possible for light sources, in particular semiconductor light sources (LEDs), to be arranged on the rear side of the housing 2 that is oriented in the direction of travel 3, the light of which sources shines through the transparent portions 23a (cf. FIG. 3) or the entire transparent cover element 23 in order to produce any desired illumination function. It would further be conceivable for a camera to be installed on the rear side of the mirror 1, which camera captures the carriageway in front of the two-wheeled vehicle through the transparent portions 23a or through the entire transparent cover element 23.

Finally, it is also noted that the rotational and/or movement directions 107, 108, 109, 402, 403 shown in the figures and described above are indicated merely by way of example and could also be oriented in manners other than those shown and described here.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. A method for manufacturing a rear-view mirror for a two-wheeled vehicle, the rear-view mirror comprising a housing and a reflective surface, said method including the steps of:
manufacturing a blank for the housing from a metal, preferably aluminium, and
forming the reflective surface as an integral component of the housing by mechanically machining at least a part of a surface of the housing such that the reflective surface is formed in one piece with the housing.

2. The method as set forth in claim 1, wherein the part of the housing that forms the reflective surface is mechanically machined using a cutting tool.

3. The method as set forth in claim 1, wherein, following the mechanical machining, a protective layer that is transparent after curing or baking is applied at least to the part of the housing that forms the reflective surface.

4. The method as set forth in claim 3, wherein the housing is shaped into the desired external contour thereof by mechanical machining after the part of the housing that forms the reflective surface has been coated with the protective layer.

5. A rear-view mirror for a two-wheeled vehicle, comprising a housing and a reflective surface, the housing being designed to be fastened to the two-wheeled vehicle by a fastening element, wherein the reflective surface is an integral component of the housing and is formed in one piece therewith by mechanically machining a part of the housing.

6. The rear-view mirror as set forth in claim 5, wherein the housing is formed in one piece from metal, in particular aluminium.

7. (canceled)

8. The rear-view mirror as set forth in claim 5, wherein the part of the housing that forms the reflective surface of the rear-view mirror is provided with a transparent protective layer after mechanical machining, the protective layer being a curable liquid varnish, a baked powder coating or a SiOx layer deposited in a plasma.

9. The rear-view mirror as set forth in claim 8, wherein the protective layer is designed to protect the reflective surface from chemical stress, in particular from discolouration on account of solar radiation, more particularly UV rays, and from corrosion on account of weather influences, and from mechanical stress, in particular from scratches.

10. The rear-view mirror as set forth in claim 5, wherein the housing comprises a fastening portion, outside the part of the housing that forms the reflective surface, for fastening a proximal portion of the fastening element.

11. The rear-view mirror as set forth in claim 10, wherein the fastening portion and the proximal portion of the fastening element are operatively interconnected such that it is possible to adjust the rear-view mirror relative to the fastening element and transversely to a main plane of extension of the reflective surface.

12. The rear-view mirror as set forth in claim 5, wherein the rear-view mirror comprises a cover, preferably made of plastics material, that is fastened to the housing and is outside the part of the housing that forms the reflective surface.

13. The rear-view mirror as set forth in claim 12, wherein the cover extends at least over part of a surface on the rear side of the housing that is opposite the reflective surface.

14. The rear-view mirror as set forth in claim 5, wherein the rear-view mirror comprises at least one light source, preferably a semiconductor light source, outside the part of the housing that forms the reflective surface.

15. The rear-view mirror as set forth in claim 14, wherein the rear-view mirror comprises a plastics material cover that is fastened to the housing and is outside the part of the housing that forms the reflective surface, which cover comprises transparent portions at least in part and is positioned relative to the at least one light source such that light emitted by the at least one light source passes through the transparent portions of the cover.
